(19) United States
(12) Patent Application Publication
(10) Pub. No.: US 2014/0223819 A1
(43) Pub. Date: Aug. 14, 2014

(54) Integrated aquaponic aquarium system

(71) Applicant: Ryan Coghlan, Corvallis, OR (US)

(72) Inventor: Ryan Coghlan, Corvallis, OR (US)

(21) Appl. No.: 13/766,746

(22) Filed: Feb. 13, 2013

(51) Int. Cl. A01K 63/04; A01G 31/02; A01K 63/00; A01G 1/00

(52) U.S. Cl. CPC A01K 63/045; A01G 1/001; A01G 31/02; A01K 63/003
USPC 47/62 R; 47/59 R; 119/259

(57) ABSTRACT

An inexpensive, complete integrated aquaponic aquarium system that uses air pressure to pump water and waste from the bottom of an aquarium into a planter where terrestrial plants are grown. Included in this system is an aquarium lighting system, unique undergravel funnel filter system, grow lights, aquarium heater, and a power regulation system that turns the grow light on and off in regular intervals.

### CROSS-REFERENCES TO RELATED APPLICATIONS

This application claims priority to U.S. Provisional Patent Application Ser. No. 61/598,244 filed on Feb. 13, 2012 entitled “A small scale aquaponic planter and aquarium system for use at the home or office”, the disclosure of which is hereby incorporated by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### SEQUENCE LISTING

Not Applicable

### BACKGROUND OF THE INVENTION

1. Field of the Invention

This invention relates generally to the field of aquaponics and/or hydroponic planters for growing traditional soil-grown plants such as herbs and flowers in a soil-less environment.

2. Description of the Related Art

Aquaponics is the symbiotic technology of growing plants hydroponically (without organic growing material such as dirt) using aquatic animal waste as the primary nutrient source. Traditional hydroponic systems use a full spectrum of plant macro and micro nutrients derived from natural or unnatural sources which are dissolved in water in a nutrient reservoir which is then pumped or poured over the roots of plants. High concentrations of nutrients and large amounts of gas exchange allow hydroponic plants to achieve extremely efficient growth rates. Aquatic animals such as fish naturally produce waste as they metabolize food and oxygen. This waste is then degraded by microorganisms into macro and micro nutrients that make nearly complete plant fertilizer. Fish produce liquid waste in the form of ammonia and solid waste that is degraded by microorganisms into ammonia and other nitrogenous wastes. These ammonia waste products are poisonous to aquatic animals and converted via biological filtration first into nitrite, another poisonous waste product, and then into relatively non-poisonous nitrate by Nitrosoma and Nitrobacter communities of naturally occurring bacteria. An aquaponic system with established bacterial communities and a steady stream offish waste can generate plant growth equal to or greater than that of traditional hydroponic technologies.

Hydroponic systems are related to aquaponic systems in that they use neutral or inert growth media such as gravel, pearlite, expanded clay, etc. as a means to support plant roots and maintain, moisture levels for the roots. Hydroponic systems generally use liquid nutrients derived from natural or un-natural sources, which are broken down into their purest forms before being added to a hydroponic growth system. There are generally no solid or liquid waste particles that need to be degraded by microorganisms in a hydroponic system.

Prior art in U.S. Pat. No. 5,385,590 describes one such small personal hydroponic system. In this system, a nutrient solution is added to the bottom reservoir which is then intermittently pumped into a bed of inert media on top, which then drips back into the lower reservoir through simple flat drainage holes. While this system works fine with dissolved hydroponic nutrients, waste from fish or other aquatic animals contains waste particles of various sizes that need to be captured and degraded naturally to maintain a clean and healthy aquarium environment. In the same system, roots from the terrestrial plants tend to find flat drainage holes and grow down into the nutrient reservoir. Over time these roots can clog the drainage holes, which can drown the plant due to a flooded planter. The roots can also become unsightly in the case of an aquaponic system, as they fill the aquarium and choke out aquatic life.

Traditional aquaponic systems cycle water from a fish reservoir to a separate plant reservoir indefinitely. Plant roots absorb waste nutrients from the water and turn the nutrients into organic plant material, cleaning the water for recirculation into the fish reservoir. Aquaponic systems are usually composed of many components including large fish tanks, soil-free plant growth beds and neutral media, natural or artificial lighting sources, mineralization tanks, sump tanks, electric pumps and solid waste filtering mechanisms. These systems have the ability to produce large quantities of harvestable fish and plants but can cost many thousands of dollars in material costs, require a large area for growth, and require many hours of labor and know-how for installation and maintenance.

Aquaponic technology is scalable and can be applied to small scale aquarium systems. Hobby aquarists use mechanical, biological and chemical filtration in their aquariums to make healthy and clean environments for aquatic organisms such as fish to live. These systems often employ the use of rotary impellor or air powered airlift pumps to suck dirty water from the aquarium, clean it by means of filtration, and then return the water back to the aquarium. Over time solid waste accumulates in the bottom of the fish tank, requiring the aquarium substrate to be vacuumed on a regular basis. This solid waste also creates a great deal of ammonia as it decomposes, which is converted via nitrification into nitrate and leads to high levels of nitrate in the aquarium water. At low levels nitrate is non-toxic to aquatic organisms but becomes toxic at high levels and can lead to unsightly and potentially deadly algae blooms in an aquarium. Aquarists therefore need to perform weekly water changes of around 25% total volume to lower overall nitrate levels in the aquarium. Chemical filtration in the form of activated carbon and zeolite is also used by aquarists to adsorb nitrogenous waste, but needs to be removed and replaced on a regular basis as the adsorptive capacity of these particles become saturated over time. Aquaponic technology uses plants to lower this nitrate level naturally by turning excess waste into plant material, thereby reducing the need to perform water changes, replace chemical filtration materials, and also greatly decreasing the amount of algae growing in the aquarium.

Another downfall of current aquarium filtration mechanisms is the inability to gather solid waste, or mulm, that accumulates on the bottom of the aquarium. Undergravel filters use airlift pumps or impellor pumps to create a low pressure zone under the aquarium substrate, creating a constant flow of oxygenated water through the aquarium substrate at the bottom of a tank. This oxygenated water allows nitrifying bacteria to partially decompose this solid waste, but vacuuming of the aquarium substrate at the bottom of the tank is often necessary to remove large waste particles. Without occasional vacuuming, these undergravel filters tend to compact and become plugged with solid waste, having a detrimental effect on the aquarium chemistry and health of the system.

Related small aquaponic and hydroponic systems use external air pumps to power filter systems along with accessory lighting systems to create healthy plant growth. Combining these external systems into one easy to use integrated unit with push-button electronic controls and a single electrical output would be attractive to users who are looking for an easy to use aquaponic aquarium system.

It is therefore an object of this invention to create an attractive, fully integrated, affordable, and easy to use aquaponic aquarium system that keeps pet fish or other aquatic organisms healthy while growing terrestrial plants as a part of the aquarium filter mechanism. It is also an object of this invention to create a unique undergravel filtration system to decrease aquarium cleaning requirements by sending aquarium waste directly to the roots of growing plants.

### BRIEF SUMMARY OF THE INVENTION

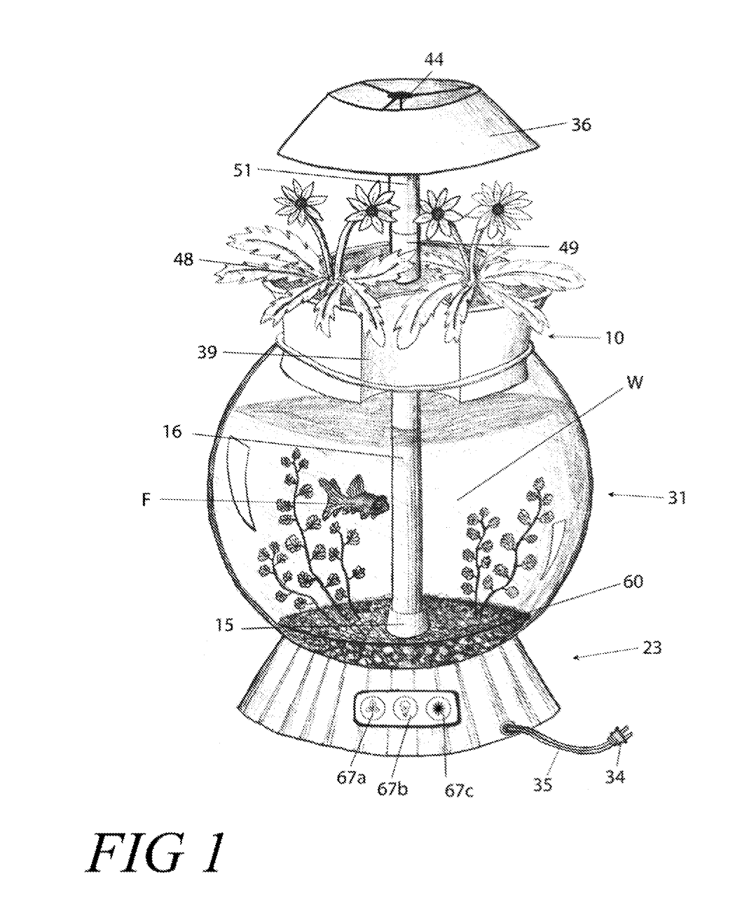

FIG. 1 is a perspective view of the invention

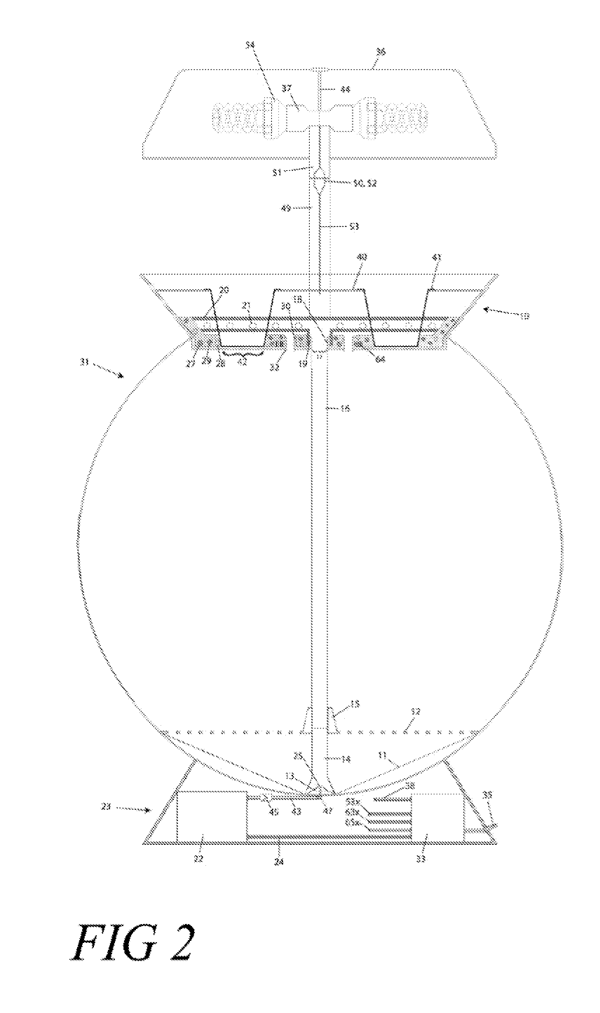

FIG. 2 is a sectional view from the front of the invention

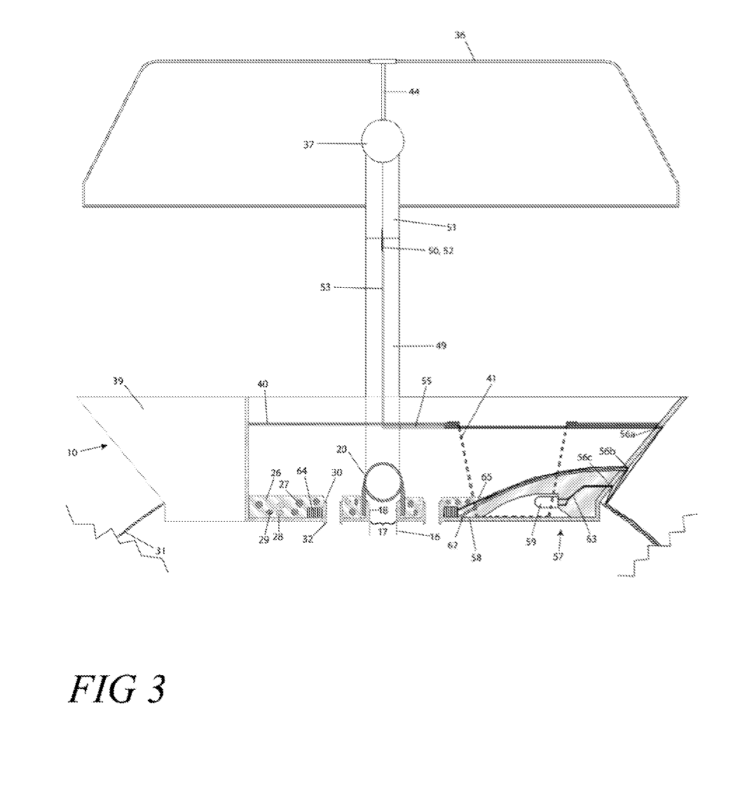

FIG. 3 is a sectional view from the side of this invention, showing only the planter and grow light section of the present invention

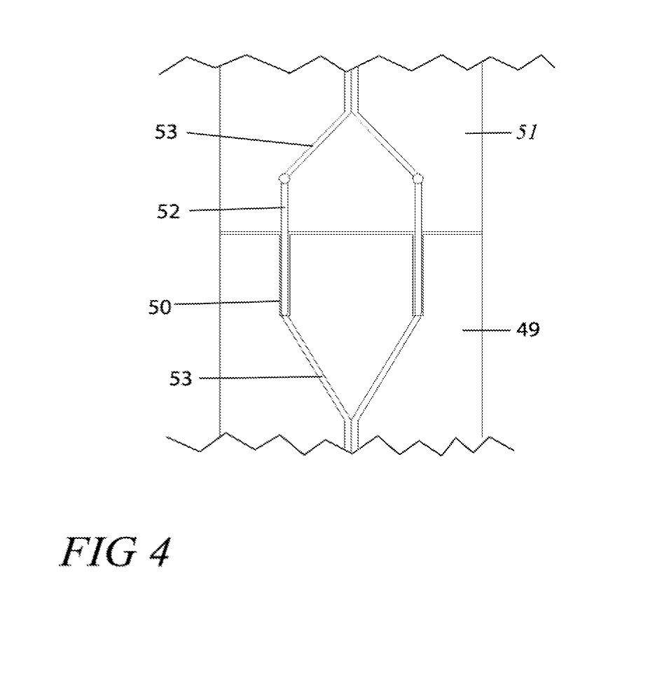

FIG. 4 is a close up view of the connection wiring in the light shaft of the grow light for the present invention.

In accordance with the invention, a contained aquaponic aquarium system is provided that uses compressed air from an air pump hidden in the base of the aquarium to pump liquid and solid fish waste (also known as mulm) through a riser tube into a planter resting on top of the tank. The bottom of this planter contains layers of filamentous material embedded with activated carbon, zeolite and calcium carbonate granules to provide biological and chemical filtration for the aquarium. A riser tube runs from the bottom of the aquarium into the center of the planter, where it connects to a watering tube with holes cut out of it that allows the waste-laden water to be pumped evenly over the filamentous material embedded with chemical filtration components such as activated carbon and zeolite. Solid waste particles are trapped in this filamentous material and are degraded by communities of bacteria that aid with the reduction of this waste into nitrates that can be absorbed by plant roots. This water then drains through the bottom of the planter through raised drainage holes and back into the aquarium cleaned and oxygenated for the aquatic organisms living within. Plants grow in grow plugs that fit into net baskets within the planter, and the roots exit the net baskets and enter the filamentous layer to absorb waste from the filter. The bottom of the aquarium contains a screen over a funnel that functions to concentrate the solid waste toward an opening at the bottom of the riser tube. Air released from the air pump outlet rises within the riser tube, taking solid and liquid waste with it from the bottom of the aquarium into the planter located above the tank.

Embedded in the bottom of the planter is an aquarium lighting system used to light the aquarium that can be controlled by a button on the base of the aquarium system. This aquarium lighting system has a gasket around the edges of it that allow the light housing to stay dry and lower the risk of electric shock. An electric cord runs out through the back of the aquarium lighting compartment on the outside of the aquarium and plugs into a port in the base of the aquarium which then connects to a power regulator hidden in the aquarium base, and then to a push button control panel at the front of said aquarium base.

In the center of the planter is a grow light adaptor. A grow light can be plugged into this adaptor to provide light for efficient plant growth. An electric cord runs from the bottom of the grow light adaptor, through a water proof tube and out through a port in the back of the planter, then runs down the outside of the aquarium and connects to the base of the aquarium in a similar fashion as the aquarium lighting system. Finally, an aquarium heater also exists within the planter that is powered by an electrical cord that exits the planter just below the grow light cord and connects to the aquarium base as well through the same plug system described previously.

A push button control panel exists at the front of the base on the bottom of the aquarium that is connected to the power regulator and regulates the amount of time the grow lights are turned on. In this embodiment, pre-programmed cycles are used to operate the grow lights so that they turn on and off in an ideal cycle for vegetative plant growth or flowering. Another button is shown in this embodiment that functions in turning the aquarium lighting system on and off manually by the user.

### DETAILED DESCRIPTION OF THE INVENTION

In the following detailed description, reference is made to specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the specification and drawings, appropriately interpreted, along with the full range of equivalents to which the specification and drawings are entitled.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

Referring now to FIGS. 1-4 of the present invention, an aquarium 10 has aquatic organisms such as fish F and water W therein. An air pump 22 is concealed inside an aquarium base 23, which is connected via an electrical cord 24 to power regulator 33. Power regulator 33 is connected to an external power source such as a standard wall outlet or equivalent via electrical cord 35 and plug 34. An airline 43 runs from air pump 22 to a one way valve 45, and then on to elbow airline connector 47 entering through a hole in the bottom of aquarium 31. Elbow airline connector 47 leads to air output 25, which releases air as bubbles into lower riser tube section 14. Riser tube section 14 has an opening 13 that sits at the bottom of a solid waste capture funnel 11 at the bottom of aquarium 31. On top of the solid waste capture funnel 11 sits an undergravel filter screen 12. On top of undergravel filter screen 12 sits aquarium substrate 60. Lower riser tube section 14 is connected to riser tube junction IS through the bottom, while riser tube 16 connects to the top. Riser tube 16 then connects to planter 10 via planter opening 17, and its advance into watering tube adaptor 19 is arrested by ring structure 18. Watering tube adaptor 19 aids with the attachment of watering tube 20. Watering tube 20 has a plurality of watering holes 21 in its structure that water pumped from riser tube 16 escapes out of.

At the bottom of planter 10 exists a mat of filamentous material 26 that is embedded with granules of activated carbon 27, zeolite 28, and calcium carbonate 29. Poking through this filamentous material 26 are raised drainage holes 30. Water drains back into aquarium 31 via these raised drainage holes 30 and is directed into the tank via drainage lips 32. At the front of planter 10 exists a cutout portion 39 that acts as a portal to the inside of the aquarium. Fitting inside planter 10 is a planter insert 40 that contains net baskets 41. These net baskets sit in holes 42 within the filamentous material 26, allowing the baskets to sit on the bottom of planter 10. Plant growth plugs (not shown) or equivalent hydroponic media are placed within each net basket for plants to grow in.

Being a complete contained aquaponic system, there are many wiring and lighting systems used in this system that will be described now. In the center of planter 10 exists a lower light shaft 49 with female plug 50 embedded in its top and grow light wires 53 connected to this plug. An upper light shaft 51 contains male plugs 52 that fit together with female plugs 50, that connect grow light wires 53 from the upper and lower light shaft creating a removable light attachment. Upper light shaft 51 contains grow light wires 53 that connect to grow light sockets 37. Within the grow light sockets 37 grow light bulbs 54 are inserted. These grow light bulbs are contained within a grow light hood 36 that directs light toward the planter. Grow light hood 36 is supported by grow light hood support 44, which is attached to the top of upper light shaft 5. Lower light shaft 49 contains the bottom half of grow light wires 53 that continue down the shaft until being encased in a waterproof tube 55 that runs just underneath planter insert 40 and then out of the planter via hole 56a. These electrical wires run down the side of aquarium 31 and plug into a port on aquarium base 23 (not shown) that in turn connects to power regulator 33 at 53x. Embedded within the bottom of planter 10 is an aquarium lighting system 57 that consists of a detachable outer wall 58, a light bulb 59, a waterproof gasket system 62, and aquarium light electrical wires 63. These electrical wires exit the planter via hole 56b and plug into a port on aquarium base 23 that in turn connects to power regulator 33 at 63x. Resting in the very bottom of planter 10 is an aquarium heater 64. This heater has electrical cord 65 that runs along the bottom of planter 10 and out through hole 56c, which then plugs into aquarium base 23 that in turn connects to power regulator 33 at 65x.

Aquarium base 23 is hollow and contains air pump 22, power regulator 33. At the back of aquarium base 23 are input ports (not shown) that allow the electrical cords from the grow lights, aquarium light, and aquarium heater to attach. At the front of aquarium base 23 is a touch pad 66, that is connected to power regulator 33 via wires 38, that controls the aquarium light and grow light cycles for the plants via the power regulator 33. Button 67a is for vegetative growth, button 67b is used to activate or deactivate the aquarium light and 67c activates a pre-programmed flowering lighting schedule.

In the operation of this aquaponic invention, lower riser tube section 14 is inserted into the bottom of riser tube junction 15 (which is connected to undergravel filter screen 12) and then placed above solid waste capture funnel 12 in the bottom of aquarium 31 so that opening 13 is centered over air output 25. Solid waste capture funnel 11 concentrates waste towards opening 13 so that when bubbles are released from air output 25, suction occurs and pumps waste laden water up through lower riser tube section 14, then up through riser tube 16 and then into planter 10. Air pump 22 provides air to air output 25 which powers the airlift through riser tube sections 14 and 16, respectively. Air pump 22 pumps air through airline 43, which travels through one way valve 45 and then to elbow connector 47, which is attached to air output 25. One way valve 45 is necessary to stop the flow of water from the aquarium into the air pump and creating a risk for electrical shock. Aquarium substrate 60 is placed on top of undergravel filter screen 12 to weigh down the undergravel filter screen, provide surface area for biological filtration, and aids in the re-creation of a natural environment for the aquatic organisms. Riser tube 16 attaches to planter 10 via planter opening 17 and is pushed into planter 10 until it reaches ring structure 18 which stops its movement into watering tube 20. Watering tube adaptor 19 acts as a juncture for watering tube 20 to attach to planter 10, while a plurality of watering holes 21 within watering tube 20 allow water and waste to exit the tube evenly in both halves of the planter. Filamentous material 26 captures solid waste and also creates a suitable environment for beneficial bacterial communities to grow and become part of the biofilter in the system. Activated carbon 27 and zeolite 28 embedded within filamentous material 26 aids in chemical filtration of the tank by adsorbing nitrogenous waste in the system. Calcium carbonate 29 is also embedded in filamentous mat 26 as a pH buffering system. Once water and waste exit watering tube 20 it pools on the bottom of planter 10 and then drips back into aquarium 31 through raised drainage holes 30. These raised drainage holes 30 function to create a pool of water in the bottom of the planter that aids in small particle settling, increases the adsorption time for the activated carbon 27 and zeolite 28 particles, and are resistant to roots growing through them and into the aquarium below. Drainage lips 32 aid in the drainage of water into aquarium 31 so the water does not run along the bottom of planter 10. At the front of planter 10 is a cutout portion 39 that allows the user to access the inside of the aquarium to feed the fish, add water to the aquarium, or take water samples. Resting inside of planter 10 is planter insert 40 that holds net baskets 41 so they sit within holes 42 within the fibrous mat. Within net baskets 41 plant growth plugs or other plant growth media is inserted (not shown) that create an area for plants 48 to germinate and grow. These plant growth plugs can be embedded with organic fertilizer and pH buffering constituents such as lime to supplement the nutrients needed to grow healthy plants efficiently.

Located in the center of planter 10 is a lower light shaft 49 that has female plugs 50 embedded in its top. This lower light shaft allows upper light shaft 51 to plug into the embedded female plugs 50 with its male plugs 52 (FIG. 4). The upper shaft is also expandable, allowing the light to be raised or lowered depending on the growth of the plants. Having two shafts that connect via a male and female plug allows the light to be removable for ease of shipping and assembly for the user, although a detachable shaft is not necessarily needed to create a suitable grow light system and is therefore not intended to be included in a limiting sense. At the top of upper light shaft 51 are grow light sockets 37 that have grow light wiring 53 leading down through shaft 51 and connecting to male plug 52. An electrical connection is made when male plug 52 and female plug 50 are connected, completing a circuit for grow light wires 53, which travel from grow light socket 37 down through upper light shaft 51, through the electrical junction formed between male plug 52 and female plug 50, then through waterproof tube 55 and out through hole 56a within the side of planter 10. The grow light wires 53 then travel on the outside of aquarium 31 and attach to a port on the back of aquarium base 23, which then attach to power regulator 33 via wires 53x. Grow light bulbs 54 are inserted into grow light sockets 37. In this embodiment compact fluorescent bulbs are shown but any lighting source able to generate plant growth could be used in this arrangement. At the top of upper grow light shaft 51 is a grow light hood support 44 that supports grow light hood 36 and aids in directing the grow light toward the plants 48 growing in planter 10.

In addition to a grow light, planter 10 in this embodiment contains an aquarium lighting system 57 which is formed in the bottom of planter 10. This aquarium lighting system 57 contains a detachable outer wall 58 that is fitted with a waterproof gasket system 62 that keeps water and moisture out of the lighting system. The aquarium light bulb 59 has aquarium light electrical wires 63 that provide electricity to the bulb, and exit the planter through hole 56b and then plug into aquarium base 23, which is connected through wires to power regulator 33 at 63x. A flat circular aquarium heater 64 is also included in this invention that rests at the bottom of planter 10 and is used to heat the water of the tank. Aquarium heater electrical cord 65 powers the aquarium heater with electricity and exits planter 10 through hole 56c and then attaches to aquarium base 23, which then connects to power regulator 33 via wires 65x.

Focusing now on the operation of the base of the aquarium 23, its design is hollow and acts to support aquarium 31 while housing and protecting components such as an air pump 22, power regulator 33 and their associated wires. Air pump 22 is powered by an electrical cord 24 that is connected to power regulator 33. Electrical wires from the grow light socket 37, the aquarium lighting system 57, the aquarium heater 64 and air pump 22 all connect to aquarium base 23 (not shown) and then their respective wires connect to power regulator 33, which is in turn controlled by touch pad 66. Touch pad 66 connects to power regulator via wires 38 and contains three buttons in this embodiment. Button 67a turns the grow light on for vegetative plant growth, 67b turns the aquarium light on and off, and 67c turns the grow light on for flowering plant growth cycle. A person skilled in the art could potentially program and install a vast array of control buttons for touch pad 66, and those buttons described in this embodiment are not used to limit the scope of this invention, but are merely one embodiment used in this invention. Power regulator 33 supplies all the power to each of the systems described and has pre-programmed lighting schedules within it that turn the grow light off and on at the appropriate times. An electrical cord 35 and plug 34 lead from the power regulator 33 to an external power source such as an electrical outlet (not shown) or perhaps a solar panel system to provide electrical power to the regulator.

Thus, it is apparent that there has been provided, in accordance with the invention, an aquaponic system for use with aquatic organisms in aquariums that fully satisfies the objects, aims and advantages set forth above. Although certain example methods, functions, features, components, and abilities have been described herein, the scope of coverage of this invention is not limited thereto. On the contrary, this invention covers all methods, functions, features, components, and abilities fairly falling within the scope of the description either literally or under the doctrine of equivalents.

With respect to the above description then, it is to be realized that the optimum methods, functions, features, components, and operation of the aquaponic planter are deemed readily apparent and obvious to one skilled in the art, and all equivalent relationships to those described in the description are intended to be encompassed by the aquaponic planter.

Therefore, the foregoing is considered as illustrative only of the principles of the aquaponic planter. Further, since numerous modifications and changes will readily occur to those skilled in the art, it is not desired to limit the aquaponic planter to the exact construction and operation shown and described, and accordingly, all suitable modifications and equivalents may be resorted to, falling within the scope of the aquaponic planter. While the above description describes various embodiments of the present invention, it will be clear that the present invention may be otherwise easily adapted to fit any configuration where an aquaponic planter for use in the home, office, or school is desired or required.

As various changes could be made in the above methods, functions, features, components, and abilities without departing from the scope of the invention, it is intended that all matter contained in the above description shall be interpreted as illustrative and not in a limiting sense.

What is claimed is:

1. A contained aquaponic aquarium system, comprising:
an aquarium that houses aquatic organisms and water, an air pump located within an aquarium base, a planter that rests on top of the aquarium that contains net baskets which further contain grow plugs for the growing of terrestrial plants, a riser tube that extends from the bottom of the aquarium to the planter that permits waste-laden water to be pumped into the planter by way of an airlift effect, layers of filamentous material located within the planter that trap solid waste particles, a watering tube within the planter that allows waste-laden water to be pumped over the layers of filamentous material, a drainage hole in the bottom of the planter through which the water drains back into the aquarium, and a screen along a section of the bottom of the aquarium that covers a funnel that concentrates solid waste from the aquatic organisms and directs the solid waste toward the bottom opening of the riser tube.

2. The contained aquaponic aquarium system of claim 1, wherein the air pump pumps air into an airline that outputs air in the bottom section of the riser tube.

3. The contained aquaponic aquarium system of claim 2, wherein the output of air into the bottom section of the riser tube creates the airlift effect that pumps the waste-laden water into the planter.

4. The contained aquaponic aquarium system of claim 1, wherein the layers of filamentous material are embedded with activated carbon, zeolite and calcium carbonate granules that provide biological and chemical filtration.

5. The contained aquaponic aquarium system of claim 1, wherein the terrestrial plants are grown in the grow plugs that fit into the net baskets within the planter.

6. The contained aquaponic aquarium system of claim 1, wherein the drainage hole is raised from the bottom of the planter so that pools of water are created in the bottom of the planter and the adsorption time for the activated carbon and zeolite particles is increased.

7. The contained aquaponic aquarium system of claim 6, wherein the pools of water aid in small particle settling.

8. A method for growing terrestrial plants without using soil, comprising:
providing an aquarium environment for aquatic organisms, capturing solid waste from the aquatic organisms, transporting the captured solid waste and water from the aquarium environment through a riser tube to a planter that is located on top of the aquarium environment, wherein the captured solid waste and water is transported to the planter by an airlift effect within the riser tube, trapping the solid waste in layers of filamentous material that are located in the planter, allowing the roots of the terrestrial plants to enter the layers of filamentous material so that the roots may absorb the trapped solid waste, and providing at least one drainage hole in the bottom of the planter so that water may drain back into the aquarium environment after it has passed through the layers of filamentous material.

9. The method of claim 8, wherein the solid waste from the aquatic organisms is captured by an undergravel filter screen that is located underneath an aquarium substrate.

10. The method of claim 9, wherein the undergravel filter screen is located on top of a solid waste capture funnel.

11. The method of claim 10, wherein the solid waste capture funnel concentrates the captured solid waste into the riser tube.

12. The method of claim 8, wherein the airlift effect is created by pumping air through an airline to the bottom section of the riser tube and allowing the air to exit from the airline into the bottom section of the riser tube so that bubbles rise through the water in the riser tube.

13. The method of claim 8, wherein the captured solid waste is filtered from the water in the planter by the layers of filamentous material.

14. The method of claim 13, wherein the filamentous material is embedded with activated carbon, zeolite, and calcium carbonate granules.

15. An aquaponic apparatus, comprising:
an airlift effect apparatus that transports solid waste from aquatic organisms to a planter, a chemical filtration component in the planter that traps the solid waste from the aquatic organisms, a bacteria growth medium containing bacteria that degrade the solid waste, a watering tube that distributes water and the solid waste from the aquatic organisms over the chemical filtration component, a net basket within the planter that contains growth plugs for the growing of terrestrial plants, a solid waste capture component that captures the solid waste from the aquatic organisms and delivers the solid waste to the airlift effect apparatus, and an aquarium for housing the aquatic organisms.

16. The aquaponic apparatus of claim 15, wherein the airlift effect apparatus further comprises a riser tube extending from the aquarium to the planter, an airline that delivers pumped air to the lower section of the riser tube, and an air pump that pumps air into the airline.

17. The aquaponic apparatus of claim 16, wherein the airlift effect is created by pumping air through the airline to the bottom section of the riser tube and allowing the air to exit from the airline into the bottom section of the riser tube so that bubbles rise through the water in the riser tube.

18. The aquaponic apparatus of claim 15, wherein the chemical filtration component is a layer of filamentous material.

19. The aquaponic apparatus of claim 15, wherein the bacteria growth medium is a layer of filamentous material.

20. The aquaponic apparatus of claim 15, wherein the growth plugs are positioned in the planter so that the roots of the terrestrial plants extend into the chemical filtration component.
